(19) United States
(12) Patent Application Publication
(10) Pub. No.: US 2026/0161535 A1
(43) Pub. Date: Jun. 11, 2026

(54) COMPUTER-IMPLEMENTED TEST ENVIRONMENT, AND METHOD FOR TESTING SOFTWARE COMPONENTS

(71) Applicant: Robert Bosch GmbH, Stuttgart (DE)

(72) Inventors: Fabian Franzelin, Tuebingen (DE); Jochen Kokemueller, Ostfildern (DE)

(21) Appl. No.: 18/716,755

(22) PCT Filed: Nov. 21, 2022
(86) PCT No.: PCT/EP2022/082593

§ 371 Date: Jun. 5, 2024

(30) Foreign Application Priority Data
Dec. 23, 2021 (DE) 10 2021 214 973.1

(51) Int. Cl. G06F 11/3698; G06F 11/3668

(52) U.S. Cl. CPC G06F 11/3698; G06F 11/3688; G06F 11/3692

(57) ABSTRACT

A computer-implemented test environment and a method for testing software components provided for execution on a specified target system. Each software component includes a sequence of a schedulable program steps, and the time period from initiating a program step to completely processing the program step is defined as the response time of the executing system for this program step. The testing takes place using a test system, on which the software components to be tested are executed with test input data, and using a time model, which describes a system-state-dependent relationship between the temporal behavior of software components during execution on the target system and the temporal behavior of these software components during execution on the test system. At least one test system characteristic variable describing the current state of the test system is recorded during the execution of a software component to be tested on the test system.

### FIELD

The present invention relates to a computer-implemented test environment and to a method for testing software components provided for execution on a specified target system. Each software component comprises a sequence of a plurality of schedulable program steps, so-called runnables. This can be a function, a thread, or also a process. The time period from initiating a program step to completely processing the program step is defined as the response time of the executing system, i.e., target system or test system, for this program step. The testing takes place by means of a test system, on which the software components to be tested are executed with test input data, which is also referred to as a recompute. Also used in testing is a time model that describes a system-state-dependent relationship between the temporal behavior of software components during execution on the target system and the temporal behavior of these software components during execution on the test system.

### BACKGROUND INFORMATION

In the software development for time-critical applications, such as applications in the field of automated driving, so-called AD (automated driving) applications, the temporal behavior of the individual software component during execution on the target system plays an essential role. In a great many applications, the software components must be tested with a plurality of test data sets in order to represent a variety of test scenarios.

Often, the target system is not available in the test phase since it is extremely complex and is designed specifically for the particular application and/or because its use in the test phase is not economical. In practice, simulations or analytical performance models of the target system that run on common hardware systems are therefore frequently used to evaluate the temporal behavior of software components on such target systems.

The temporal behavior of a software component on a system, i.e., test system or target system, is intertwined with the functional and non-functional properties of that system. It depends on a plurality of influencing variables, such as the function code of the software component itself, the compiler, the libraries used, the hardware architecture, and the distribution of the individual program steps to the available hardware resources. These influencing variables are not independent of one another; rather, the timing of the individual program steps or function steps, and thus the temporal behavior of the software component as a whole, changes depending on all these aspects.

X. Zheng, P. Ravikumar, L. K. John and A. Gerstlauer, “Learning-based analytical cross-platform performance prediction, ” 2015 International Conference on Embedded Computer Systems: Architectures, Modeling, and Simulation (SAMOS), 2015, pp. 52-59, doi: 10.1109/SAMOS.2015.7363659 describes using a learning-based analytical model to estimate the performance of software components during the execution on a target system. In the training phase of this model, a training set of different software components is executed both on the test system and on a temporally accurate simulation of the target system. In the process, characteristic performance variables are recorded on the test system and corresponding performance references are recorded on the simulation of the target system. Inherent in these measured variables is the relationship between test system and target system, which relationship is extracted during the training phase and represented in the analytical model. After completion of the training phase, the trained analytical model is used as follows to test software components: The software component to be tested is executed only on the test system. In the process, characteristic performance variables of the test system are recorded. On the basis of these characteristic performance variables of the test system, the pre-trained model then estimates the performance of the software component on the target system.

This procedure can only be used to make quantitative statements on the overall performance of the tested software component on the target system. A qualified statement on how the individual program steps have affected the overall performance is not possible here and, accordingly, neither is a causal analysis.

### SUMMARY

The present invention provides measures that allow the temporal behavior of software components to be tested on a target system to be realistically and credibly simulated during the execution on a test system, viz., reproducibly for each individual schedulable program step of the software component to be tested.

According to an example embodiment of the present invention, this may be achieved by means of a sequence planning component, which is designed to perform the scheduling of the individual program steps during the execution of a software component to be tested on the test system. To this end, the sequence planning component estimates the response times of the target system for the individual program steps, taking into account the current state of the test system by means of the time model. On the basis of this estimate, the sequence planning component then specifies to the test system a response time that corresponds to the temporal behavior of the target system in a comparable state.

Accordingly, during the execution of a software component to be tested, current test system characteristic variables are regularly recorded and transmitted to the sequence planning component, where they are interpreted as information on the current state of the test system. In addition, the test system transmits a response time request for the respectively current program step to the sequence planning component. The time model of the sequence planning component then generates an estimate for the response time of the current program step on the target system, taking into account the current state of the test system. The sequence planning component then responds to the response time request of the test system with a specification for the response time that is selected such that, during the execution of the current program step in the context of the software component to be tested, the test system simulates the temporal behavior of the target system in a comparable state.

The measures according to the present invention make discrete event simulation driven both by the execution of the software component to be tested and by the sequence planning component or its time model possible. Both are kept synchronous so that the response times for the respectively current program step that are provided by the time model are always calculated on the basis of the current consistent state of the test system. The thus specified response times are reproducible with the same input, i.e., state of the test system and program step, and with the same design of the target system so that the test system, together with the sequence planning component according to the present invention, realistically and credibly simulates the temporal behavior of software components to be tested on the target system.

The measures according to the present invention thus make qualified statements on how the individual program steps affect the overall performance of a software component on the target system possible. This information is of great use for software development.

It is also particularly advantageous that the measures according to an example embodiment of the present invention make a realistic assessment of the overall performance of a tested software component on the target system possible, and not just an estimate as described in the related art. This assessment may simply be based on the output data that have been generated depending on the test input data when the software component to be tested was executed on the test system. These output data are referred to as test output data below. For example, for assessing the overall performance, the test output data may be compared to the output data that an earlier version of the tested software component has generated for the same test input data.

Within the scope of the present invention, the specification of the response times of the test system for the individual program steps of the software components to be tested can in principle take place in different ways. In an advantageous embodiment of the present invention, trigger events for the program steps of the software component to be tested are generated for this purpose. These trigger events may be both trigger events that initiate a program step and trigger events that terminate a program step. Preferably, such trigger events are generated by the sequence planning component of the computer-implemented test environment according to the present invention.

As already mentioned, the time model used within the scope of the present invention describes a relationship between the temporal behavior of software components during execution on the target system and the temporal behavior of these software components during execution on the test system, if the two systems, i.e., target system and test system, are in a comparable state. That is to say, the time model requires information on the state of the test system during execution of a software component, in order to make statements on the temporal behavior of the target system in a comparable state during execution of this software component. Within the scope of the present invention, test system characteristic variables that more or less comprehensively describe the state of the test system are therefore recorded. To this end, the computer-implemented test environment according to the present invention comprises corresponding hardware-implemented or software-implemented recording means. During the execution of a software component to be tested, one or more of the following test system characteristic variables are thus recorded:
processor time of a program step (net execution time),
wait/delay times during the execution of a program step (time spent waiting for execution resources, e.g., cores),
wait/delay times when accessing data stores/sources (data-access-related delay),
latency due to data storage structures (intrinsic latency of memory hierarchy),
delay times when accessing bus and network (bus-and network-access delay),
scheduling-related delays,
middleware latency,
complexity of the test input data (input data complexity, number of messages on the input ports, message payload analysis metrics).

In a preferred embodiment of the present invention, the time model comprises at least one pre-trained regression model, in particular a neural network. Training such a learning-based time model is explained by way of example in connection with FIG. 2 below.

As an alternative or also in addition to a pre-trained regression model, the time model could also comprise at least one simulation component that takes into account specified system parameters of the target system, in particular parameters of the hardware architecture, of the operating system, of the scheduler used, of the software distribution to a given hardware architecture (deployment model), and priority models of program steps.

Of particular importance is the use of the present invention in testing software components within the scope of the development of AD applications. The target system is generally an embedded application-specific hardware-open-loop system (HoL), whereas a software-open-loop system (SoL) based on a common hardware system can advantageously be used as the test system.

### BRIEF DESCRIPTION OF THE DRAWINGS

Advantageous embodiments and developments of the present invention are explained below with reference to the figures.

FIG. 1 illustrates the cooperation of the individual components of a test environment 100 according to an example embodiment of the present invention on the basis of a first block diagram.

FIG. 2 illustrates the training of a time model and the use thereof within the scope of the method according to an example embodiment of the present invention on the basis of a second block diagram, which shows the flow of information between the individual components of a test environment 200 according to the present invention.

### DETAILED DESCRIPTION OF EXAMPLE EMBODIMENTS

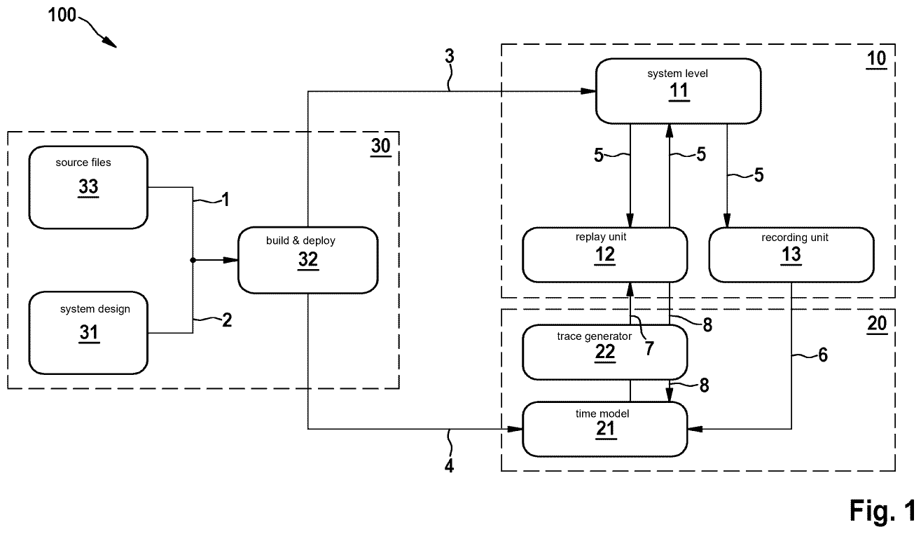

FIG. 1 is a “quasi-static” representation of the components of a test environment 100 according to the present invention for testing software components that are provided for execution on a specified target system. For example, the target system could be part of an AD project. Although, the target system is not part of the test environment 100. However, in the embodiment example described here, information 30 on the software portions and the specification of the hardware of the target system, such as information on the system design 31 and the software compilation and software distribution 32 (build & deploy) on the target system, are available to the test environment 100. The software components to be tested have been developed for the target system. Each software component comprises a sequence of a plurality of schedulable program steps. The software components are executed with test input data in the test environment 100 for testing purposes. The software components and the test input data are in the form of source files 33. The temporal behavior of the software components to be tested during the execution on the target system is simulated by means of the test environment 100 according to the present invention. In the process, the time period from initiating a program step to completely processing the program step, which is defined as the response time of the executing system, i.e., target system or test system, for this program step, plays an essential role.

An essential component of the test environment 100 is a test system 10, which may differ significantly from the target system both in terms of hardware and in terms of software technology. The single technical requirement that the test system 10 must satisfy is that the software components to be tested are executable on the test system 10. Generally, the test system 10 is a software implementation on a common hardware system, which is also used for consumer applications, for example.

Furthermore, according to the present invention, the test environment 100 comprises a sequence planning component 20, which uses a time model 21 for predicting the temporal behavior of software components during execution on the target system. This is because this time model 21 describes a relationship between the temporal behavior of software components during execution on the target system and the temporal behavior of these software components during execution on the test system 10, if target system and test system are in a comparable state. For example, the time model 21 may use machine learning models for its predictions or may also use stochastic approaches from uncertainty assessment or error analysis (uncertainty quantification), such as polynomial chaos expansion.

In the embodiment example shown here, the time model 21 also uses available target system information 30 on system design 31 and software compilation and software distribution 32 for its predictions, which is indicated by the arrows 2 and 4. The arrows 2 and 3 illustrate that the target system information 30 is also used at the system level 11 of the test system 10, for example in order to adjust system parameters, to the extent that this is possible.

The arrows 1 and 3 illustrate that the source files 33 of the software components to be tested and of test input data are provided to the test system 10. The execution of a software component to be tested with a particular set of test input data in which a corresponding set of test output data is generated is also referred to as a recompute. The execution of the software components takes place on a replay unit 12 of the test system 10, which replay unit communicates for this purpose with the system level 11, which is indicated by arrows 5. Furthermore, the test system 10 comprises a recording unit 13 with hardware-implemented and/or software-implemented recording means for test system characteristic variables that describe the state of the test system 10 during execution of the individual program steps of the software components to be tested.

The current test system characteristic variables (arrow 6) are transmitted together with a response time request (arrow 8) for the currently executed program step to the sequence planning component 20. The time model 21 interprets the test system characteristic variables as information on the current state of the test system 10 and thus generates an estimate for the response time of the current program step on the target system in a comparable system state. The sequence planning component 20 then responds to the response time request of the test system 10 (indicated by arrow 7) with a specification for the response time of the test system 10 so that, during the execution of the current program step in the context of the software component to be tested, the test system 10 simulates the temporal behavior of the target system. In order to specify the response times of the test system 10, in the embodiment example shown here, a trace generator 22 of the sequence planning component 20 generates, at suitable times, trigger events that initiate or terminate a program step. The information on the initiation and termination of the individual program steps is also referred to as trace data and may be represented in the form of a Gantt chart.

From the point of view of the sequence planning component 20, the software components to be tested during the execution on the test system 10, i.e., the recomputes, are the users or consumers of the trace data in that they schedule the individual program steps, i.e., the runnables, according to the trace data generated by the sequence planning component. This ensures that, when the same trace data are used, a recompute is reproducible and also provides reproducible test output data.

According to the present invention, the sequence planning component 20 thus assumes the entire scheduling of the software components to be tested, viz., in parallel to the execution of the software component on the test system 10. To this end, the sequence planning component 20 estimates the response times of the target system for the individual program steps by means of the time model 21 and taking into account the current state of the test system 10. This estimate is the basis for the specification of a response time for the test system 10 that corresponds to the temporal behavior of the target system in a comparable system state. Due to the differences between target system and test system 10, the response time specified to the test system 10 is generally not identical to the estimated response time of the target system. However, the test system response times of all program steps of a software component are selected such that they simulate the temporal behavior of the software component as a whole on the target system, but that all test system response times are, for example, slower or faster by a factor than the estimated response times of the target system.

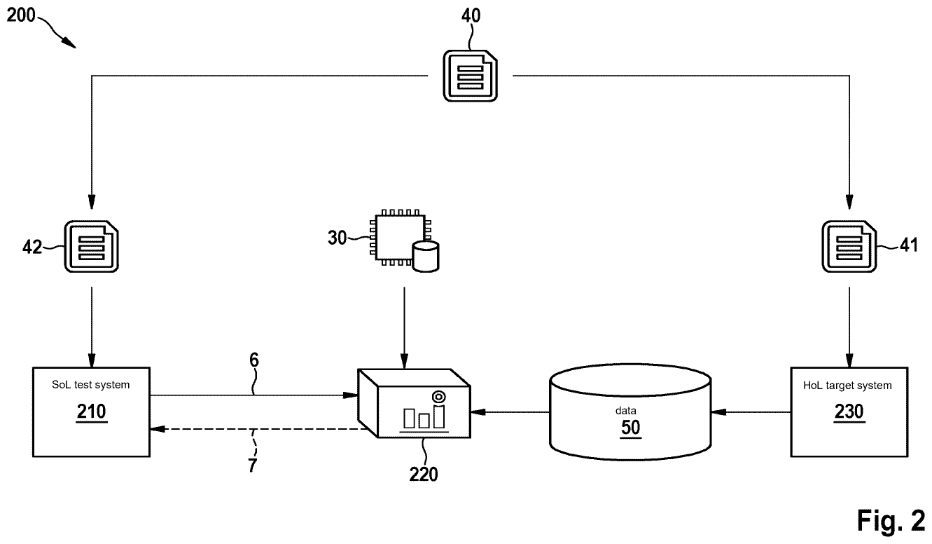

The block diagram of FIG. 2 relates to a test environment 200 according to the present invention with a Sol test system 210 and with a sequence planning component that uses a time model with a regression model 220 to estimate response times of a Hol target system 230 for individual program steps. The right half of FIG. 2 relates solely to the training of such a time model 220; the left half also shows the use thereof within the scope of the method according to the present invention.

In the training phase, the regression model 220, for example a neural network, is to learn the relationship between the temporal behavior of software components during execution on a Hol target system 230 and the temporal behavior of these software components during execution on the Sol test system 210, by means of training software in order, after completion of the training phase, to estimate the temporal behavior of software components on the Hol target system 230 on the basis of test system characteristic variables recorded during execution of these software components on the Sol test system 210.

Representative training software components are selected in a first step for this purpose. The corresponding source code 40 is compiled for the Hol target system 230 on the one hand and for the Sol test system 210 on the other hand, producing the program code 41 executable on the Hol target system 230 and the program code 42 executable on the Sol test system 210. In a next step, these two program codes 41 and 42 are then executed with the same training input data on the respective system, i.e., HOL target system 230 and Sol test system 210, respectively. In so doing, both the HOL target system 230 and the Sol test system 210 record characteristic variables describing the state of the respective system, such as
processor time of a program step (net execution time),
wait/delay times during the execution of a program step (time spent waiting for execution resources, e.g., cores),
wait/delay times when accessing data stores/sources (data-access-related delay),
latency due to data storage structures (intrinsic latency of memory hierarchy),
delay times when accessing bus and network (bus-and network-access delay),
scheduling-related delays,
middleware latency,
complexity of the test input data (input data complexity, number of messages on the input ports, message payload analysis metrics).

Thus, corresponding hardware-implemented and/or software-implemented recording means measure when a runnable is initiated, when its execution is deferred, and when processor resources are again assigned to it, until its execution is finally terminated. Non-functional performance model counters together with an analysis of functional input data of runnables can also be logged.

All these data 50 recorded for the Hol target system 230 and data recorded, in parallel thereto, for the Sol test system 210 (indicated by arrow 6) are used to train the regression model 220 by means of machine learning methods.

After completion of the training phase, the regression model 220 is able to provide, without the software component to be tested having to be executed on the HOL target system 230, a better or poorer prediction or estimate for the response times of the individual program steps on the Hol target system 230 on the basis of information on the state of the Sol test system 210 during execution of a software component to be tested. After the training phase, the Hol target system 230 can therefore be decoupled from the time model 220 of the test environment 200.

In the embodiment example shown here, the predictions of the regression model 220 also include system-specific information 30 on the HOL target system 230, such as information on system design and software compilation and software distribution (deployment model).

The left half of the block diagram of FIG. 2 illustrates that, according to the present invention, during the execution of a software component 42 to be tested, the Sol test system 210 regularly, here with each program step, records test system characteristic variables and transmits (arrow 6) them together with a response time request to the sequence planning component (not shown separately here) with the pre-trained time model 220. The sequence planning component responds to this request with a specification for the response time on the Sol test system 210, which is based on the estimate of the time model 220 for the response time of the Hol target system 230 (arrow 7). The sequence planning component of the test environment 200 according to the present invention thus assumes the entire scheduling of the program steps or runnables of a Sol recompute.

The above description of embodiment examples explains that the temporal behavior of software components to be tested on a HOL target system can be reproducibly and credibly simulated on a Sol test system by means of the measures according to the present invention. This is in particular made possible by using a time model that describes a system-state-dependent relationship between the temporal behavior of software components during execution on the target system and the temporal behavior of these software components during execution on the test system.

1-10. (canceled)

11. A computer-implemented test environment for testing software components provided for execution on a specified target system, wherein each software component includes a sequence of a plurality of schedulable program steps, and wherein a time period from initiating a program step to completely processing the program step is defined as a response time of an executing system for the program step, wherein the test environment comprises:
a test system configured for executing software components to be tested with test input data;
a hardware-implemented and/or software implemented recording arrangement for test system characteristic variables describing a state of the test system during execution of the software component to be tested;
a time model which describes a system-state-dependent relationship between a temporal behavior of software components during execution on a target system and a temporal behavior of the software components during execution on the test system;
a sequence planning component, which is configured to perform scheduling of individual program steps during execution of a software component to be tested on the test system, the sequence planning component configured to estimate the response times of the target system for the individual program steps using the time model, taking into account a current state of the test system, and to specify a corresponding response time to the test system.

12. The computer-implemented test environment according to claim 11, wherein the sequence planning component is configured to generate trigger events for the program steps of the software component to be tested, so that each program step is initiated or terminated by a trigger event.

13. The computer-implemented test environment according to claim 11, wherein the hardware-implemented and/or software-implemented recording arrangement is provided for one or more of the following test system characteristic variables:
processor time of a program step,
wait/delay times during the execution of a program step,
wait/delay times when accessing data stores/sources,
latency due to data storage structures,
delay times when accessing bus and network,
scheduling-related delays,
middleware latency,
complexity of the test input data.

14. The computer-implemented test environment according to claim 11, wherein the time model includes at least one pre-trained regression model including a neural network.

15. The computer-implemented test environment according to claim 11, wherein the time model includes at least one simulation component that takes into account specified system parameters of the target system, the parameters including at least one of:
parameters of a hardware architecture,
parameters of an operating system,
parameters of a scheduler used,
parameters of a software distribution to a given hardware architecture,
priority models of program steps.

16. The computer-implemented test environment according claim 11, wherein the target system is a hardware-open-loop system (HoL), which is specified for a self-driving vehicle, and the test system is realized in the form of a software-open-loop system (SoL).

17. A computer-implemented method for testing software components provided for execution on a specified target system, wherein each software component includes a sequence of a plurality of schedulable program steps, wherein a time period from initiating a program step to completely processing a program step is defined as a response time of an executing system, wherein the testing takes place using a test system, on which the software components to be tested are executed with test input data, and using a time model, which describes a system-state-dependent relationship between a temporal behavior of software components during execution on a target system and a temporal behavior of the software components during execution on the test system, the method comprising:
during execution of a software component to be tested on the test system:
recording at least one test system characteristic variable describing a current state of the test system; and
estimating a response time of the target system for a current program step using the time model, taking into account the current state of the test system; and
specifying a corresponding response time to the test system.

18. The computer-implemented method according to claim 17, wherein, based on the response time of the test system that is specified for a program step, at least one trigger event for the program step is generated, whereby the program step is initiated or terminated.

19. The computer-implemented method according to claim 17, wherein one or more of the following test system characteristic variables are recorded:
processor time of a program step,
wait/delay times during execution of a program step,
wait/delay times when accessing data stores/sources,
latency due to data storage structures,
delay times when accessing bus and network,
scheduling-related delays,
middleware latency,
signal payload analysis data,
complexity of the test input data.

20. The computer-implemented method according to claim 17, wherein when the software component to be tested is executed on the test system, test output data are generated depending on test input data and are used based on an assessment of the software component to be tested.
